(19) United States
(12) Patent Application Publication
(10) Pub. No.: US 2004/0174033 A1
(43) Pub. Date: Sep. 9, 2004

(54) Truck storage trunk

(76) Inventor: Jerry Lamar Webb, Louisville, MS (US)

Correspondence Address: JERRY L. WEBB, JR., 205 BUSTER MYERS ROAD, LOUISVILLE, MS, 39339, US

(21) Appl. No.: 10/713,907

(22) Filed: Mar. 6, 2002

Related U.S. Application Data
(60) Provisional application No. 60/362,291, filed on Mar. 6, 2002.

(51) Int. Cl. B60R 9/06

(52) U.S. Cl. 296/37.6

(57) ABSTRACT

A storage trunk compartment devised specifically for a truck type vehicle is disclosed and is hereafter referred to as a “truck storage trunk”. The truck storage trunk shall extend from the front of the truck's bed to half of the truck bed's length and shall be constructed in such a manner as to provide clearance between itself and the truck's wheel housing (for trucks that have wheel housings that are internal to the truck's bed). The truck storage trunk shall be built with dual trunk lids that rise when a key is used to unlock the trunk. The trunk lids shall be accessible from either side of the truck's bed. The depth of the truck storage trunk shall be sufficiently deep for the user to be able to store luggage, golf bags, groceries, camping gear, or other similar items. The purpose of the truck storage trunk is to provide a removable lightweight secure watertight storage compartment to be used for transporting of common items while providing easy access to those items.

### CROSS REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The purpose of this invention is to provide a storage trunk compartment for truck type vehicles that is very similar to a car type vehicle storage trunk compartment so that item's such as luggage, camping gear, groceries and other similar sized items can be transported in a watertight storage compartment, while allowing the storage trunk compartment to be easily removed so that the full truck bed can be used when so desired.

This invention takes a distinct advantage that cars have over trucks and brings that advantage to a truck, thereby increasing the utility of a truck as compared to a car type vehicle.

### BRIEF SUMMARY OF THE INVENTION

A truck bed mounted storage trunk compartment with dual locked trunk lids that are accessible from either side of the truck. The truck storage trunk shall be constructed from 10 gauge aluminum tread plate. The truck storage trunk shall include a solar cell that charges a battery. The battery is used to power a switch operated light that is internal to the truck storage trunk. The truck storage trunk can be used to store items such as luggage, camping gear, golf clubs, groceries, etc. as would be stored in a car trunk, while providing tool storage areas, too.

### BRIEF DESCRIPTION OF THE SEVERAL VIEWS OF THE DRAWINGS

The accompanying drawings describe the physical appearance and give typical dimensions for a truck storage trunk. As-built dimensions of the truck storage trunk will vary according to the different sizes of truck beds.

FIG. 1 shows a Front View of the truck storage trunk.

FIG. 2 shows a Side View of the truck storage trunk.

FIG. 3 shows a Top View of the truck storage trunk.

FIG. 4 shows a 3-Dimension Perspective View of the truck storage trunk.

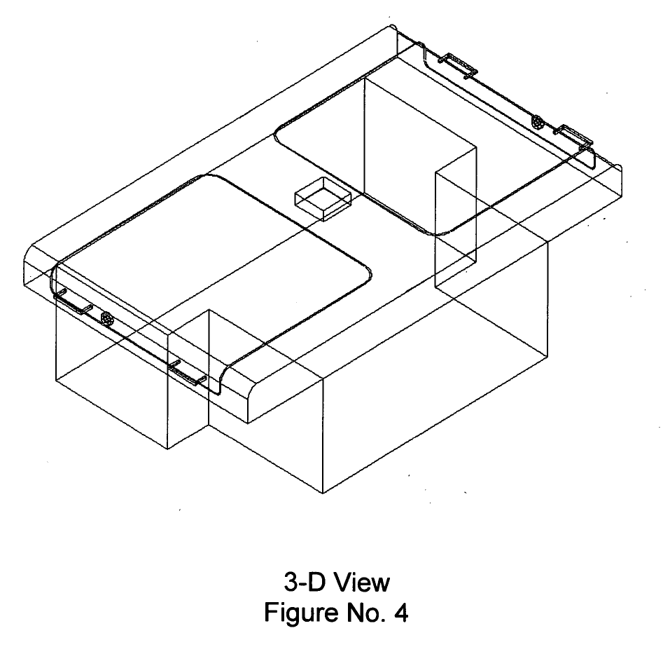

FIG. 5 shows a Shaded 3-Dimension Perspective View of the truck storage trunk.

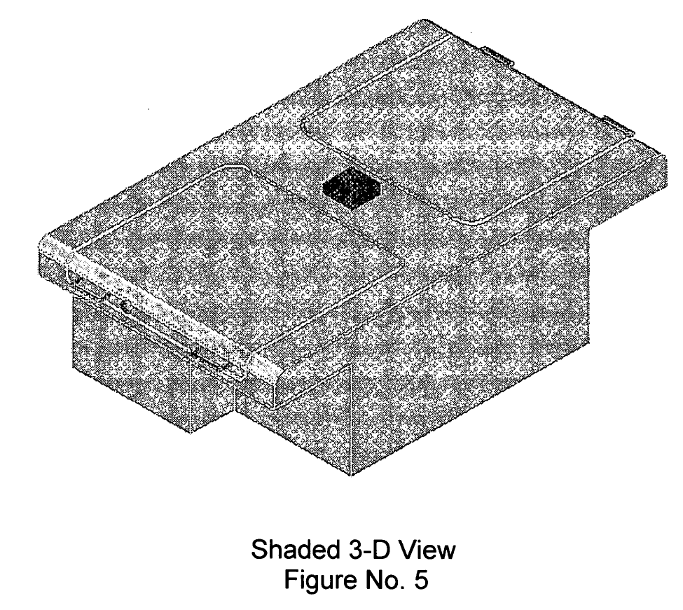

### DETAILED DESCRIPTION OF THE INVENTION

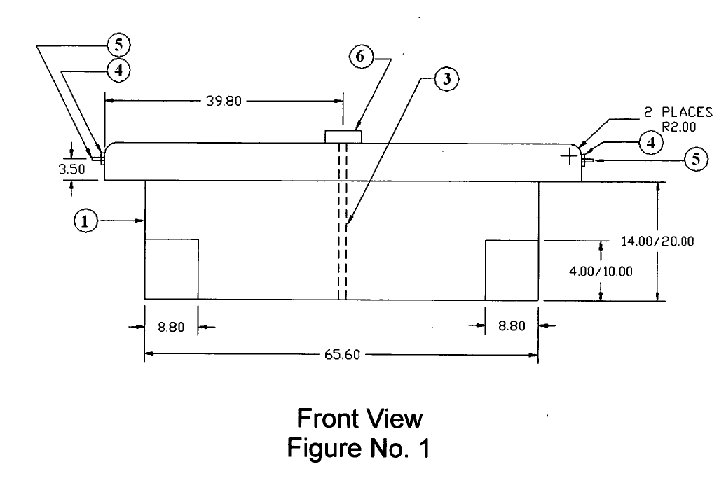

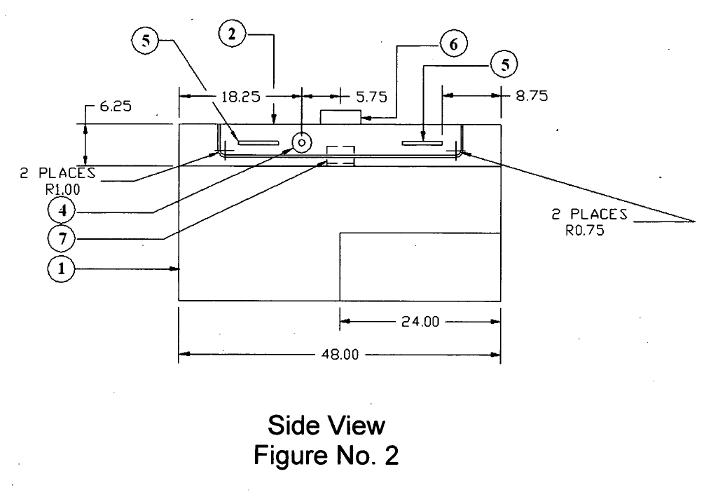

Referring to FIGS. 1 and 2, the truck storage trunk's structure (1) shall be comprised of 10 gauge aluminum tread plate.

Referring to FIG. 2, the formed trunk lid (2) shall be comprised of 10 gauge aluminum tread plate.

Referring to FIGS. 1 and 2, there are quantity 4 swivel lift handles (5).

Referring to FIGS. 1 and 2, there are quantity 2 locks (4).

Referring to FIGS. 1 and 2, there is quantity 1 solar cell (6).

Referring to FIG. 2, there are quantity 2 trunk lid lock latches (7).

Referring to FIG. 1, there is a center partition (3).

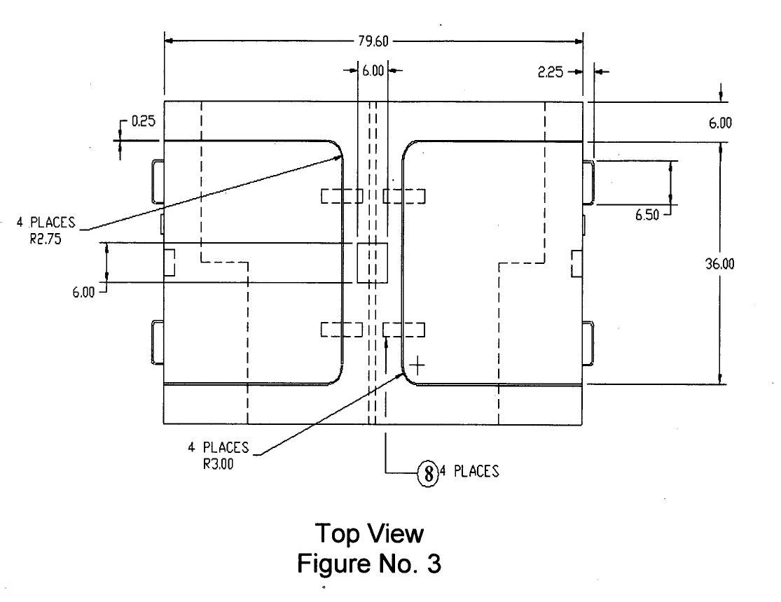

Referring to FIG. 3, there are quantity 4 trunk lifting mechanisms (8).

What is claimed is:

1. A truck storage trunk for a truck type vehicle. The said truck storage trunk shall be positioned in the truck's bed such that it extends from the front of the said truck's bed to the center of the said truck's bed and transverses from one side of the said truck's bed to the other side of the said truck's bed and extends over each side of the said truck's bed wall until the point that said truck storage trunk structure is even with each said truck bed's outer wall.

2. The said truck storage trunk as defined in claim 1 shall be comprised of dual trunk lids wherein have individual locks. Each said trunk lid shall be accessible from a side of the said truck bed's outer wall.

3. A rubber type gasket shall be used to seal the said truck storage trunk of claim 1 to the said truck storage trunk lid when closed.

4. A solar cell shall be mounted to the center top of the said truck storage trunk structure in claim 1. The said solar cell shall be used to charge a rechargeable battery.

5. The said rechargeable battery in claim 4 shall be used to power a switch-controlled light that is mounted internal to the said truck storage trunk structure defined in claim 1.

6. A removable center partition shall be provided that will be used to divide the said truck storage trunk structure in claim 1 into two separate half compartments so that items in the said truck storage trunk in claim 1 will have a limited range of motion when the said compartment divider is installed.

7. The said compartment divider in claim 6 shall be removable so that larger objects can be placed into the said truck storage trunk defined in claim 1.

8. Dual removable tool trays shall be located in the said truck storage trunk in claim 1 and shall be located directly above the said truck's wheel housings.
